(19) United States
(12) Patent Application Publication
(10) Pub. No.: US 2025/0289245 A1
(43) Pub. Date: Sep. 18, 2025

(54) RECORDING APPARATUS

(71) Applicant: CANON KABUSHIKI KAISHA, Tokyo (JP)

(72) Inventors: YOHEI KUSANO, Tokyo (JP); YUSUKE NAKAYA, Tokyo (JP); SHOICHI ZENSAI, Kanagawa (JP)

(21) Appl. No.: 19/222,956

(22) Filed: May 29, 2025

Related U.S. Application Data
(63) Continuation of application No. PCT/JP2023/035785, filed on Sep. 29, 2023.

(30) Foreign Application Priority Data
Dec. 9, 2022 (JP) 2022-197191

(51) Int. Cl. B41J 11/00; B41J 15/04; B41J 29/377

(52) U.S. Cl. CPC B41J 11/00222; B41J 15/046; B41J 15/048; B41J 29/377

(57) ABSTRACT

A recording apparatus includes a conveyance portion that conveys a sheet, and an air blowing portion that applies an air current to the sheet conveyed by the conveyance portion, wherein the air blowing portion includes an air blowing box that has an air blow-out port through which an air current to be applied to the sheet is blown, and holding portions that hold the air blowing box and are configured to be movable such that the air blowing box takes a first position where a blow-out port surface provided with the air blow-out port faces a conveyance path of the sheet and a second position where the blow-out port surface is further away from the conveyance path than when the first position is taken, and the air blowing box is configured to be attachable to and detachable from the holding portions.

### CROSS-REFERENCE TO RELATED APPLICATIONS

This application is a Continuation of International Patent Application No. PCT/JP2023/035785, filed Sep. 29, 2023, which claims the benefit of Japanese Patent Applications No. 2022-197191, filed Dec. 9, 2022, which are hereby incorporated by reference herein in their entirety.

### BACKGROUND

### Field of the Technology

The present disclosure relates to a recording apparatus including an air blowing portion that blows air to a recording material or a recording material conveyance path, and more particularly to a recording apparatus that performs recording by ejecting a recording liquid onto a continuous sheet-like recording material.

### Description of the Related Art

A recording apparatus of a liquid ejection system typified by an inkjet printer includes an air blowing fan or the like serving as an air blowing portion that blows air to a recording material or a recording material conveyance path, and includes a cooling mechanism (cooling unit) that cools ink serving as a recording liquid applied to the recording material by blowing air. PTL 1 discloses, as a configuration of a cooling mechanism, a configuration in which an air blowing box in which an air blowing fan is accommodated is detachable from a frame body side plate of the cooling mechanism. Note that examples of the air blowing mechanism (air blowing portion) provided in the recording apparatus include an air blowing mechanism (drying unit or fixing unit) that applies a hot air current to ink to dry the ink or controls a melted state of the ink to promote fixing to a recording material.

At the time of maintenance of the air blowing mechanism, in particular, in the case of, for instance, cleaning an air blowing nozzle surface of the air blowing box, work of detaching the air blowing box from the frame body side plate of the cooling mechanism occurs. In addition, in a recording apparatus that performs recording on roll paper that is a continuous sheet-like recording material, paper passing work, that is, work of spreading the roll paper over the entire conveyance path from a recording material supply portion to a recording material collection portion is required before starting a recording operation. In this case, from the viewpoint of paper passing workability, it is necessary to perform work of detaching the air blowing box from the frame body side plate of the cooling mechanism to open the conveyance path of the roll paper.

### CITATION LIST

### Patent Literature

PTL 1 Japanese Patent Application Publication No. 2014-172226

### SUMMARY

The present disclosure is directed to the technology for improving maintainability of a recording apparatus.

According to some embodiments, a recording apparatus according to the present disclosure is a recording apparatus including a conveyance unit that conveys a sheet; and an air blowing portion that applies an air current to the sheet conveyed by the conveyance portion, wherein the air blowing portion includes an air blowing box that has a blow-out port through which an air current to be applied to the sheet is blown, and a holding portion that holds the air blowing box, and is configured to be movable such that the air blowing box takes a first position where a blow-out port surface provided with the blow-out port faces a conveyance path of the sheet, and a second position where the blow-out port surface is further away from the conveyance path than in a case where the first position is taken, and the air blowing box is configured to be attachable to and detachable from the holding portion.

Features of the present disclosure will become apparent from the following description of exemplary embodiments with reference to the attached drawings.

### BRIEF DESCRIPTION OF THE DRAWINGS

FIG. 1 is a schematic cross-sectional view illustrating a configuration at the time of recording of a recording apparatus according to the present embodiment.

FIG. 2 is a schematic cross-sectional view illustrating a configuration at the time of cleaning of the recording apparatus according to the present embodiment.

FIGS. 3A to 3C are schematic diagrams illustrating a configuration example of a cooling portion according to the present embodiment.

FIGS. 4A to 4C are schematic views of an air blowing box according to the present embodiment.

FIGS. 5A to 5C are diagrams for describing an attachment/detachment configuration of the air blowing box according to the present embodiment.

FIGS. 6A and 6B are diagrams for describing the attachment/detachment configuration of the air blowing box according to the present embodiment.

FIGS. 7A and 7B are schematic perspective views of the cooling portion according to the present embodiment as viewed from the front side.

FIG. 8 is a schematic cross-sectional view illustrating an air flow circulation path of the cooling portion according to the present embodiment.

FIGS. 9A and 9B are schematic views illustrating an air flow circulation path of the cooling portion according to the present embodiment.

FIG. 10 is a control block diagram of the recording apparatus according to the present embodiment.

FIG. 11 is a flowchart illustrating flow velocity control based on a rotation speed of the air blowing fan unit.

FIG. 12 is a schematic perspective view of an air blowing box according to another embodiment of the present embodiment.

FIG. 13 is a flowchart illustrating flow velocity control based on pressure of the air blowing fan unit.

### DESCRIPTION OF THE EMBODIMENTS

Hereinafter, embodiments for performing the present disclosure will be described in detail as examples on the basis of examples with reference to the drawings. Note that the dimensions, materials, shapes, and relative disposition of the components described in the embodiment should be changed as appropriate according to the configuration of the apparatus to which the disclosure is applied and various conditions. In addition, not all combinations of features described in the present embodiment are essential to the solution of the present disclosure. The constituent elements described in the embodiments are merely examples, and the scope of the present disclosure is not intended to be limited only to them.

### Embodiments

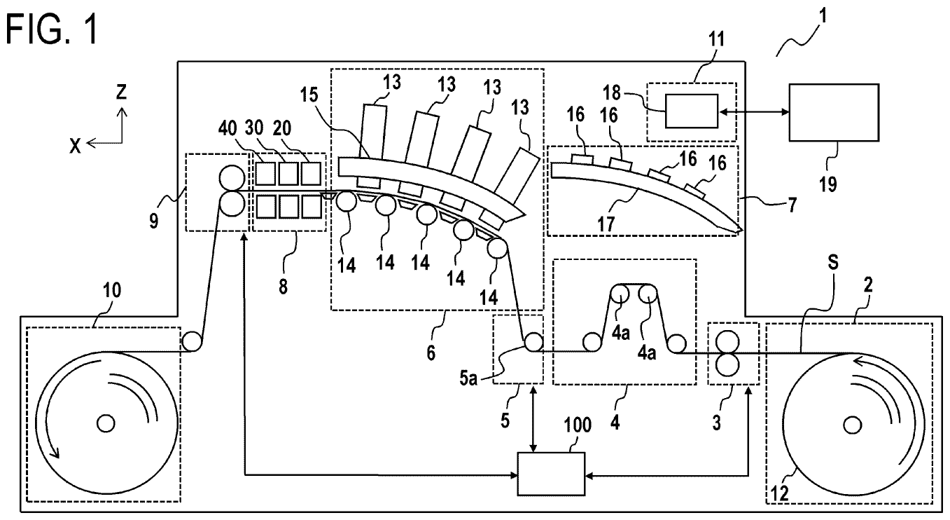

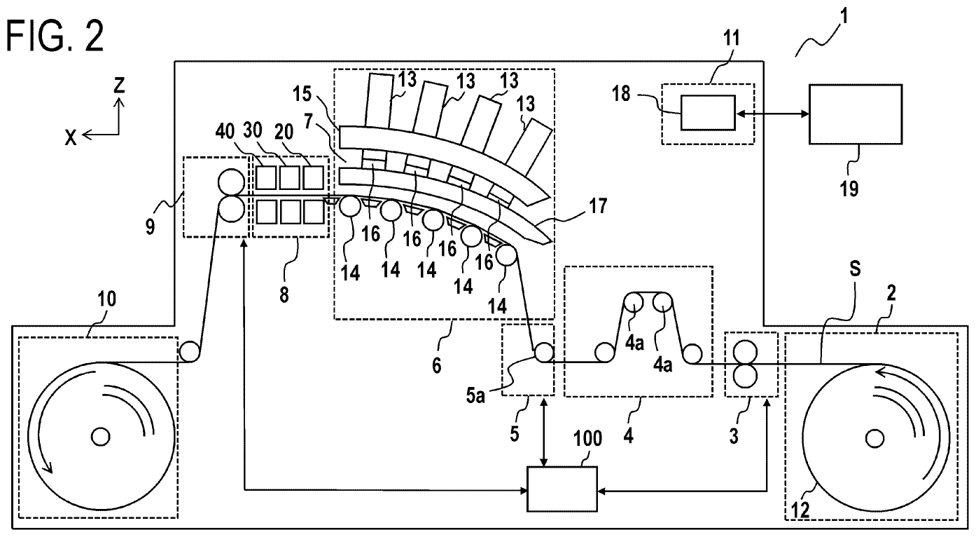

A recording apparatus 1 according to an embodiment of the present disclosure will be described with reference to FIGS. 1 and 2. First, the upper side of the paper surface of FIG. 1 is defined as an upper side, the right to left side of the paper surface is defined as a sheet conveyance direction (X direction), the front to back side of the paper surface orthogonal to the sheet conveyance direction is defined as a sheet width direction (Y direction), and the direction from the lower side of the paper surface toward the upper side of the paper surface is defined as an anti-gravity direction (Z direction). The recording apparatus 1 of the present embodiment is a high-speed line printer using a continuous sheet wound in a roll shape as a recording material. For example, the recording apparatus 1 is suitable for a printing field of mass printing in a print laboratory or the like.

FIG. 1 is a schematic cross-sectional view illustrating an internal configuration of the recording apparatus 1 during a recording operation. FIG. 2 is a schematic cross-sectional view illustrating an internal configuration of the recording apparatus 1 at the time of cleaning. The recording apparatus 1 according to the present embodiment includes units such as a sheet supply portion 2, a first conveyance roller pair 3, a meandering (skew) correction portion 4, a tension detection portion 5, a recording portion 6, a head cleaning portion 7, a post-processing portion 8, a second conveyance roller pair 9, a sheet collection portion 10, and a control portion 11. A sheet S serving as a recording material is conveyed along a sheet conveyance path indicated by a solid line in the drawing, and is subjected to processing in each unit.

The sheet supply portion 2 is a unit that holds a roll (roll portion) 12 which is a part of the continuous sheet S wound in a roll shape, and supplies an unrecorded part of the sheet S pulled out from the roll 12 from the upstream side of the conveyance path of the sheet S toward the recording portion 6. The sheet supply portion 2 stores the roll 12, and pulls out and supplies the sheet S. That is, the sheet S is a band-like long sheet-like recording material, and is a recording material of which one end is held by the sheet supply portion 2, the other end is held by the sheet collection portion 10, and the sheet S is continuously connected from the sheet supply portion 2 to the sheet collection portion 10. The sheet S is conveyed such that the holding amount in the sheet supply portion 2 decreases and the holding amount in the sheet collection portion 10 increases. That is, the sheet S is in a conveyance mode in which the sheet S is fed from the sheet supply portion 2 to the sheet collection portion 10 such that a recording target region of the sheet S between the sheet supply portion 2 and the sheet collection portion 10 sequentially changes (flows) in the conveyance direction from the sheet supply portion 2 to the sheet collection portion 10.

Note that the number of rolls that can be stored in the sheet supply portion 2 is not limited to one, and two or three or more rolls may be stored, and the sheet S may alternatively be pulled out and supplied. In addition, the sheet S is not limited to a sheet wound in a roll shape as long as the sheet S is continuous. For example, the continuous sheet S provided with the perforation for each unit length may be folded back and stacked for each perforation, and stored in the sheet supply portion 2. That is, the form of holding the sheet S in the sheet supply portion 2 and the form of holding the sheet S in the sheet collection portion 10 are typically winding in a roll shape, but are not limited thereto.

The first conveyance roller pair 3 is a unit that feeds the sheet S to the meandering correction portion 4, the tension detection portion 5, the recording portion 6, and the post-processing portion 8 disposed in this order along the sheet S conveyance path, and applies a sheet tension between the first conveyance roller pair 3 and the second conveyance roller pair 9. The first conveyance roller pair 3 is rotated by driving a motor (not illustrated), and performs tension conveyance of conveying the sheet S by applying a predetermined tension to the sheet S.

The meandering correction portion 4 is a unit for correcting the meandering in the sheet width direction at the time of tension conveyance of the sheet S. The meandering correction portion 4 includes meandering correction rollers 4a and a meandering detection sensor (not illustrated) that detects the meandering of the sheet S (an inclination with respect to the original advancing direction). The meandering correction rollers 4a can change an inclination of the sheet S by using a motor (not illustrated), and corrects the meandering of the sheet S on the basis of the measurement of the meandering detection sensor. In this case, the sheet S is wound around the meandering correction rollers 4a, so that the function of the meandering correction can be enhanced.

The tension detection portion 5 is a unit for detecting a tension when tension conveyance is performed between the first conveyance roller pair 3 and the second conveyance roller pair 9. The tension detection portion 5 includes a conveyance roller 5a having a strain gauge attached to an end thereof. The tension is detected by detecting a resistance value of the strain gauge that is output corresponding to a force applied from the sheet S to the conveyance roller 5a.

The recording portion 6 is a sheet processing portion that performs recording processing on the conveyed sheet S by ejecting ink as a recording liquid from a recording head 13 located above the sheet S to form an image or the like. The conveyance path in the recording portion 6 is formed by a plurality of guide rollers 14 and a plurality of guide members. The plurality of guide rollers 14 and the plurality of guide members are alternately disposed adjacent to each other to form an arc-shaped array protruding upward. That is, the guide rollers 14 and the guide members configure a recording portion conveyance portion that supports and conveys the sheet S at positions facing the recording heads 13. Note that, as a configuration of the recording portion conveyance portion, a configuration in which an arc-shaped conveyance path is formed only by the plurality of guide rollers 14 without providing a guide member serving as a support member may be adopted. The guide rollers 14 support the sheet S to apply a constant tension to the sheet S. By applying a constant tension to the sheet S, a clearance with the recording head 13 is secured.

A plurality of the recording heads 13 are arranged in the conveyance direction to form an arc-shaped array following the conveyance path. In the present embodiment, four line type recording heads corresponding to inks of four colors of black (Bk), yellow (Y), magenta (M), and cyan (C) are provided. Note that the number of colors and the number of the recording heads 13 are not limited to four. The plurality of recording heads 13 are integrally held by a head holder 15. The head holder 15 is configured to be movable in the up-down direction so that the clearance between the recording head 13 and the sheet S can be changed. As an inkjet method which is a recording method of the recording apparatus of the present embodiment, a method using a heat generating element, a method using a piezoelectric element, a method using an electrostatic element, a method using a MEMS element, and the like can be adopted. The ink of each color is supplied from an ink tank (not illustrated) to the recording head 13 via an ink tube.

The head cleaning portion 7 includes a cleaning unit (not illustrated) that cleans an ink ejection surface of the recording head 13 and a cap unit 16 that moisturizes the ink ejection surface of the recording head 13. The cleaning unit is variously selected according to characteristics of ink to be used such as wiping using an elastic blade made of urethane and suction using a belt-shaped cloth, nonwoven cloth, or a rubber-like suction nozzle, a recording time, and an interval, and is not limited to a specific cleaning unit. The cap unit 16 brings a rubber member molded in a vat shape into contact with the outside of an ejection nozzle region of the ink ejection surface to reduce the contact between the outside air and the ejection nozzle and curb drying. A form thereof is not limited to a specific form, and a rubber rib or the like may be disposed on a plate-shaped member, and the rib may be brought into contact with the plate-shaped member to form a sealed space. In order to make the pressure applied to the ejection nozzle equal to the atmospheric pressure, an atmosphere communication path may be provided within a range that does not affect curbing of drying. Furthermore, a negative pressure may be applied to the sealed space to suck out the ink from the nozzle. In order to enhance the moisturizing ability, liquid may be supplied into the cap to increase the humidity.

The plurality of cleaning units and cap units 16 corresponding to the plurality of recording heads 13 are adjacently disposed in an arc-shaped array and integrally held by a cleaning holder 17. The cleaning holder 17 is configured to be slidable in the sheet conveyance direction (X direction) between a cleaning position for performing various cleaning operations on the recording head 13 and a non-cleaning position separated from the recording head 13. FIG. 1 illustrates a state at the time of recording, and the head cleaning portion 7 is located at a non-cleaning position (upstream in the sheet conveyance direction, that is, on the right side of the apparatus with respect to the recording portion 6 in the drawing) retracted with respect to the recording portion 6. On the other hand, FIG. 2 illustrates a state at the time of a cleaning operation, and the head cleaning portion 7 is located immediately below the recording head 13 of the recording portion 6. In order to achieve the state illustrated in FIG. 2, the head holder 15 is raised from the state illustrated in FIG. 1, and the head cleaning portion 7 is slid to the non-cleaning position (downstream side in the sheet conveyance direction). The head holder 15 is moved downward to a position where a cleaning operation can be performed on the recording head 13. Note that the head cleaning portion 7 is not limited to including the cleaning units and the cap units 16, and may include only either the cleaning units or the cap units 16. Furthermore, a sliding direction of the head cleaning portion 7 is not limited to the sheet conveyance direction (X direction), and may be the sheet width direction (Y direction).

The post-processing portion 8 is a unit that reduces the amount of liquid contained in the ink applied to a part of the sheet S on which recording has been performed by the recording portion 6 and enhances the fixing performance between the sheet S and the ink. The post-processing portion 8 includes a drying portion 20, a fixing portion 30, and a cooling portion 40.

The drying portion 20 heats a part (recorded region) recorded on the sheet S to dry the ink applied to the part. In the drying portion 20, a hot air current is applied to at least an upper surface side (ink applied surface (recording target surface) side) of a passing part of the sheet S to dry the ink applied surface. A drying method may be configured by combining a method of irradiating the surface of the sheet S with electromagnetic waves (ultraviolet rays, infrared rays, or the like) or a conductive heat transfer method using contact of a heating element, in addition to a method of applying a hot air current.

The fixing portion 30 applies a predetermined amount of heat to a part of the sheet S dried by the drying portion 20 to soften and melt the ink, thereby improving fixing performance between the sheet S and the ink. In the fixing portion 30, a hot air current equal to or higher than the amount of heat of the drying portion 20 is applied to at least the upper surface side of the passing part of the sheet S to fix the ink applied surface. Note that a fixing method is not limited to a method of applying a hot air current, and may be a method of irradiating the surface of the sheet S with electromagnetic waves (ultraviolet rays, infrared rays, or the like), a method of nipping the sheet S with a heating element to apply heat pressure, or a combination thereof.

The cooling portion 40 cools the part fixed by the fixing portion 30 in the sheet S, solidifies the softened ink, and curbs the temperature change amount of the sheet S in a downstream process of the recording apparatus 1. In the cooling portion 40, an air current having a temperature lower than that of the sheet S is applied to at least the upper surface side of the passing part of the sheet S to cool the ink applied surface. A cooling method is not limited to a method of applying air, and may be a conductive heat transfer method using contact of a heat dissipation member or a combination thereof.

The second conveyance roller pair 9 is a unit that conveys the sheet S while applying a tension to the sheet S together with the first conveyance roller pair 3 to adjust the tension of the sheet S. The second conveyance roller pair 9 is rotated by being driven by a motor (not illustrated). A tension control portion 100 controls the torque applied to the conveyance roller 5a by a clutch (not illustrated) drivingly connected to the conveyance roller 5a according to a tension value detected by the tension detection portion 5, thereby adjusting the tension of the sheet S. As an additional configuration for adjusting the tension of the sheet S, a configuration for controlling a speed of the second conveyance roller pair 9 by using the tension detection portion 5 may be added. In this case, as tension control methods, there are two methods such as a torque control method of controlling a torque value transmitted from the clutch and a speed control method of controlling a roller speed of the second conveyance roller pair 9, and the tension control methods can be switched according to the purpose or both methods can be used at the same time.

The sheet collection portion 10 is a unit for winding a part of the sheet S that has passed through the recording portion 6 and been subjected to recording processing on a winding core located further toward the downstream side than the recording portion 6 in the sheet conveyance path. The number of rolls that can be collected is not limited to one, and the sheet S may be alternatively collected by having two or three or more winding cores. Depending on the processing content after recording, the continuous sheet S may be cut by using a cutter and the cut sheet S may be stacked instead of being wound around a winding core.

The control portion 11 is a unit that controls each portion of the entire recording apparatus 1. The control portion 11 includes a CPU, a storage device, a controller including various control portions, an external interface, and an operation portion 18 with which a user performs input and output. The operation of the recording apparatus 1 is controlled on the basis of a command from the controller or a host apparatus 19 such as a host computer connected to the controller via the external interface.

### Cooling Portion 40 of Example 1

### (Configurations of First Housing and Second Housing)

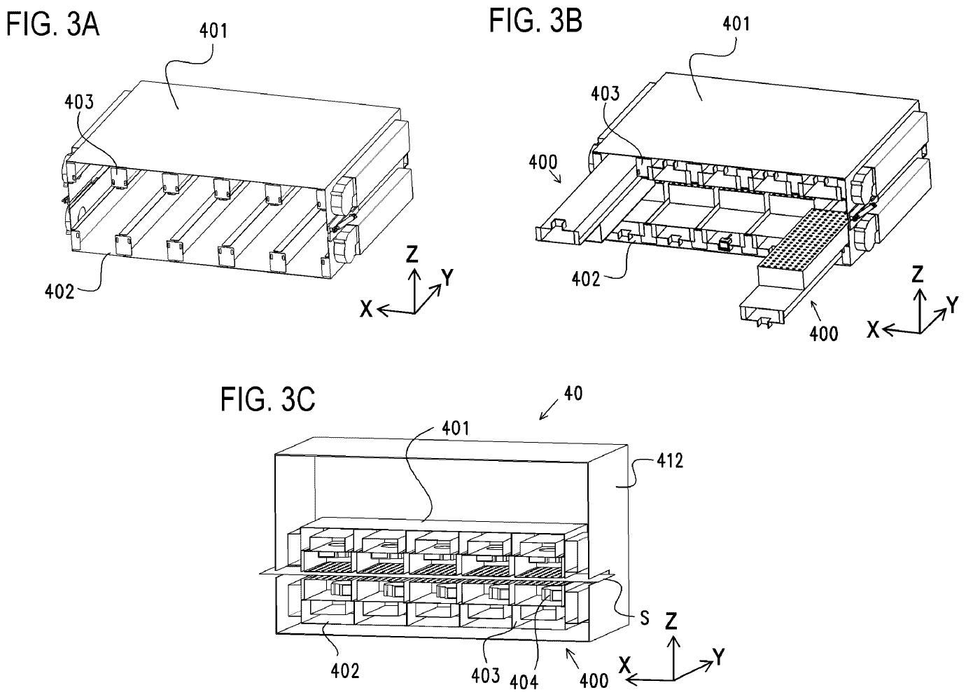

An example in which the present disclosure is applied to the above-described cooling portion 40 will be described as Example 1 of the air blowing mechanism of the present disclosure with reference to FIGS. 3A to 11. The cooling portion 40 is configured to cool the ink applied surface by applying an air current to the ink applied surface (recording target portion) of the sheet S.

FIG. 3A is a perspective view illustrating a first housing 401 and a second housing 402 of the cooling portion 40. FIG. 3B is a perspective view illustrating attachment and detachment of an air blowing box 400 to and from the first housing 401 and the second housing 402 of the cooling portion 40. FIG. 3C is a cross-sectional perspective view of an internal structure of the cooling portion 40 in the sheet width direction. Also in FIG. 3, the sheet conveyance direction is defined as the X direction, the sheet width direction is defined as the Y direction, and the direction from the bottom to the top of the apparatus is defined as the Z direction.

As illustrated in FIGS. 3A and 3B, the cooling portion 40 includes the first housing 401 as a first holding portion and the second housing 402 as a second holding portion for holding the air blowing box 400. In the first housing 401 and the second housing 402, the plurality of air blowing boxes 400 are detachably held by attachment/detachment rails 403 independently of each other.

As illustrated in FIG. 3C, each of the first housing 401 and the second housing 402 is assembled to a frame body 412 of the cooling portion 40. The first housing 401 is disposed above the sheet S to face the upper surface (first surface) of the conveyed sheet S. The second housing 402 is disposed below the sheet S to face the lower surface (second surface) opposite to the upper surface of the sheet S. In the illustrated form, a total of ten air blowing boxes 400 are held, five in each of the upper and lower sides. The plurality of air blowing boxes 400 held by the first housing 401 are disposed to be arranged in the sheet conveyance direction (X direction) as first air blowing boxes in a region facing the upper surface of the sheet S. Similarly, the plurality of air blowing boxes 400 held by the second housing 402 are disposed to be arranged in the sheet conveyance direction (X) as second air blowing boxes in a region facing the lower surface of the sheet S. The width of the air blowing box 400 in the sheet width direction (Y direction) is larger than the width of the sheet S.

The air blowing box 400 includes an air blowing fan unit 404 as an example of an air blowing unit. The air blowing box 400 is configured to take in air from the outside of the box due to an operation of the air blowing fan unit 404 and blow the taken-in air onto the sheet S. Details of the configuration of the air blowing box 400 will be described later.

The first housing 401 and the second housing 402 are assembled to the frame body 412 by adjusting a facing interval (facing interval in the Z direction) between the air blowing box 400 provided in the first housing 401 and the air blowing box 400 provided in the second housing 402. That is, in the air blowing box 400 provided in the first housing 401 and the air blowing box 400 provided in the second housing 402, the facing intervals with respect to the sheet S are adjusted to predetermined intervals to enable effective air blowing for the sheets S. In addition, the facing intervals can be changed as appropriate.

The first housing 401 is configured to be capable of being opened and closed with respect to the second housing 402. Specifically, the first housing 401 is configured to be movable such that the plurality of held air blowing boxes 400 can take an air blowing position (first position) where blow-out ports (blow-out port surfaces) thereof face the sheet S and a retraction position (second position) where the blow-out ports are further away from the sheet S than when the air blowing position is taken. Through the opening operation of the first housing 401, the facing region between the first housing 401 and the second housing 402, that is, the conveyance path of the sheet S is opened to one side in the sheet width direction (Y direction). Due to the relative disposition (conveyance path open mode) of the first housing 401 and the second housing 402, the conveyance path of the sheet S is exposed to the side, and the blow-out port surfaces of the air blowing boxes 400 are exposed to the side. Details of the opening/closing operation of the first housing 401 will be described later.

According to the cooling portion 40 of the present example, the first housing 401 and the second housing 402 are configured to be openable and closable, and the air blowing box 400 is configured to be attachable to and detachable from each housing, so that maintenance such as cleaning of the air blowing box 400 and each housing can be facilitated.

### (Configuration of Air Blowing Box)

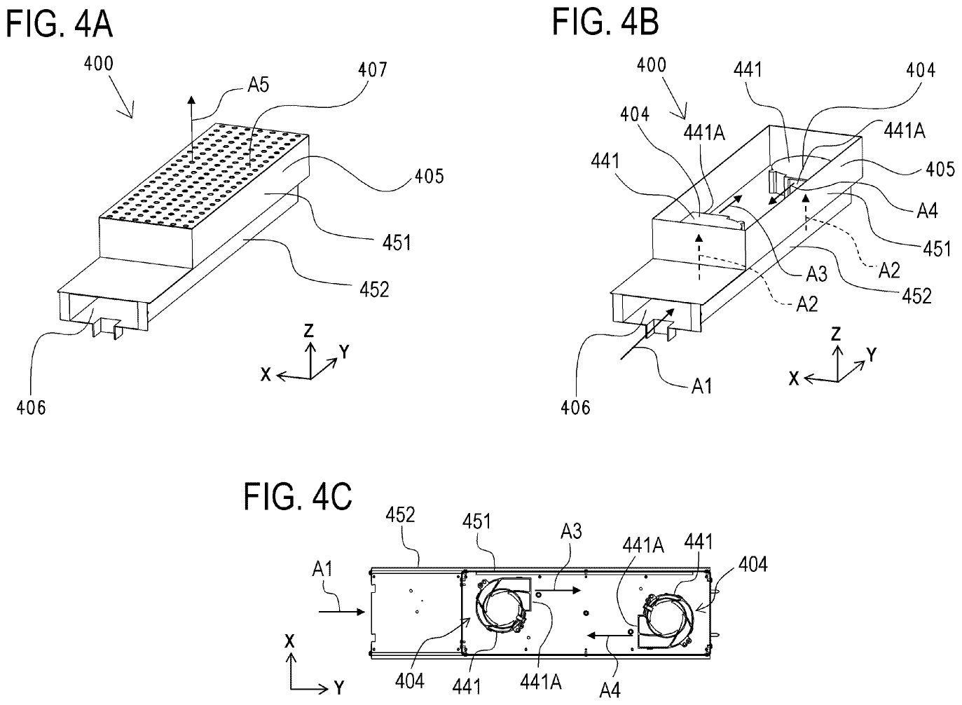

A configuration of the air blowing box 400 will be described with reference to FIG. 4. FIG. 4A is a schematic perspective view of the air blowing box 400, and FIG. 4B is a schematic perspective view in which a blow-out port surface 407 of a box housing 405 of the air blowing box 400 is not illustrated. FIG. 4C is a schematic plan view of the air blowing box 400 illustrated in FIG. 4B as viewed in a direction opposite to the Z direction.

Here, the X, Y, and Z directions of the air blowing box 400 illustrated in FIG. 4 indicate directions when the air blowing box is attached to the second housing 402. That is, the air blowing box 400 illustrated in FIG. 4 is disposed such that the blow-out port surface 407 provided with the blow-out ports faces the conveyance path of the sheet S upward (Z direction). Therefore, in a case where the air blowing box 400 is attached to the first housing 401, the disposition of the air blowing box 400 is opposite to the disposition illustrated in FIG. 4 in the Z direction, and the blow-out port surface 407 faces the conveyance path of the sheet S downward.

As illustrated in FIG. 4, the air blowing box 400 includes an air blowing fan unit 404, a box housing 405, an intake port 406, and a blow-out port surface 407. The box housing 405 has an aspect in which two box portions (a first box portion 451 and a second box portion 452) are overlapped and connected.

The first box portion 451 is provided with the air blowing fan unit 404 disposed inside thereof, and has the blow-out port surface 407 in which a plurality of blow-out ports are open on a part of the outer surface. The intake port 406 is open to the second box portion 452. The insides of the two boxes communicate with each other via the air blowing fan unit 404.

The air blowing fan unit 404 includes a casing 441 forming a flow path for blowing air, a runner (not illustrated) rotatably assembled inside the casing, and a motor (not illustrated) for rotatably driving the runner. The casing 441 includes a suction port (not illustrated) and an ejection port 441A. The air blowing fan unit 404 is configured to suck air in a rotation axis direction of the runner via the suction port and eject the air in a direction orthogonal to the rotation axis direction (the width direction of the sheet S in the present example) via the ejection port 441A. The suction port of the casing 441 is open by a partition wall partitioning between the first box portion 451 and the second box portion 452, and communicates with the flow path inside the second box portion 452. That is, the internal flow path of the first box portion 451 and the internal flow path of the second box portion 452 communicate with each other via (the suction port of the casing 441 of) the air blowing fan unit 404.

When the runner of the air blowing fan unit 404 is rotated through driving of the motor, the air enters from the suction port of the casing 441, and an air flow ejected from the ejection port 441A is formed. This air flow forms a suction air flow (arrows A1 and A2) in which the external air is sucked from the intake port 406, passes through the internal flow path of the second box portion 452, and flows into the suction port of the casing 441 of the air blowing fan unit 404. Further, the air (arrows A3 and A4) ejected from the ejection port 441A of the casing 441 of the air blowing fan unit 404 circulates in the first box portion 451, increases the internal pressure, and is blown out from the plurality of blow-out ports of the blow-out port surface 407, thereby forming a blow-out air flow (arrow A5). This blown air flow is blown onto the sheet S.

As illustrated in FIGS. 4B and 4C, two air blowing fan units 404 (a first air blowing fan unit and a second air blowing fan unit) are disposed in the first box portion 451. The box housing 405 (the first box portion 451 and the second box portion 452) of the air blowing box 400 of the present example is formed to be long in the width direction of the sheet S, and the air blowing fan unit 404 is disposed at both ends of the sheet S in the width direction in the first box portion 451. That is, one of the two air blowing fan units 404 is disposed on one side in the width direction (Y direction) of the sheet S inside the first box portion 451, and the other air blowing fan unit 404 is disposed on the other side in the width direction (Y direction) of the sheet S.

The two air blowing fan units 404 are disposed to face each other in the width direction (Y direction) of the sheet S. One air blowing fan unit 404 (first air blowing fan unit) ejects the air introduced from the outside of the air blowing box 400 toward the side where the other air blowing fan unit (second air blowing fan unit) is disposed in the first box portion 451. Similarly, the other air blowing fan unit 404 (second air blowing fan unit) ejects the air introduced from the outside of the air blowing box 400 toward the side where one air blowing fan unit (first air blowing fan unit) is disposed in the first box portion 451. That is, the air ejected from the ejection ports 441A of the two air blowing fan units 404 travels from both end sides of the sheet S in the width direction toward the center inside the first box portion 451, and is blown out from the blow-out ports of the blow-out port surface 407 while forming the circulating air flow described above. Further, the two air blowing fan units 404 are disposed such that positions of the respective ejection ports 441A in the conveyance direction (X direction) of the sheet S are shifted from each other. As a result, the circulating air flow described above is efficiently formed inside the first box portion 451, and the air flow blown out from the plurality of blow-out ports of the blow-out port surface 407 is made uniform.

The blow-out port surface 407 is a surface included in the outer surface of the first box portion 451 and facing the sheet S, and has a plurality of blow-out ports that are open, the blow-out ports each including a round hole having a small diameter (for example, 2 to 10 mm). The plurality of blow-out ports are disposed at equal intervals in a direction (the X direction or the Y direction) orthogonal to the facing direction (Z direction) with respect to the sheet S, and are configured such that uniform air is blown out from the plurality of blow-out ports to the sheet S. A hole shape of the blow-out port is not limited to a round hole, and may be a linear slit hole or a combination thereof.

The air blowing fan unit 404 is electrically connected to the control portion 11 of the recording apparatus 1 and controlled by the control portion 11 in a state in which the air blowing box 400 is attached to the first housing 401 or the second housing 402. The rotation speed of the motor of the air blowing fan unit 404 is controlled in response to an instruction from the control portion 11 (see FIG. 1), and the flow velocity of the air blown onto the sheet S from the blow-out ports of the blow-out port surface 407 is used in a range of approximately 10 m/s to 30 m/s.

### (Attachment and Detachment of Air Blowing Box)

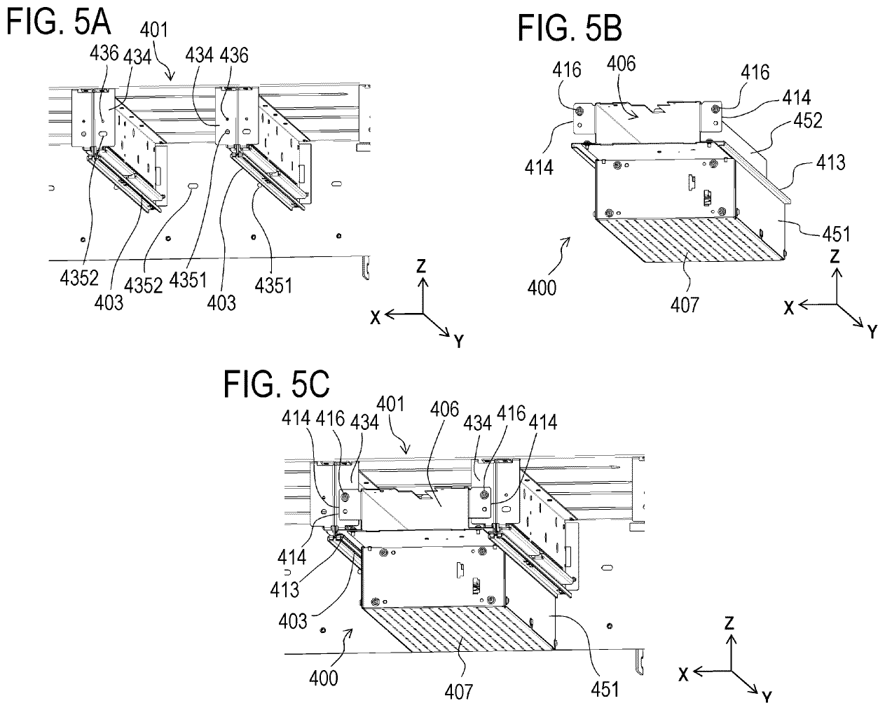

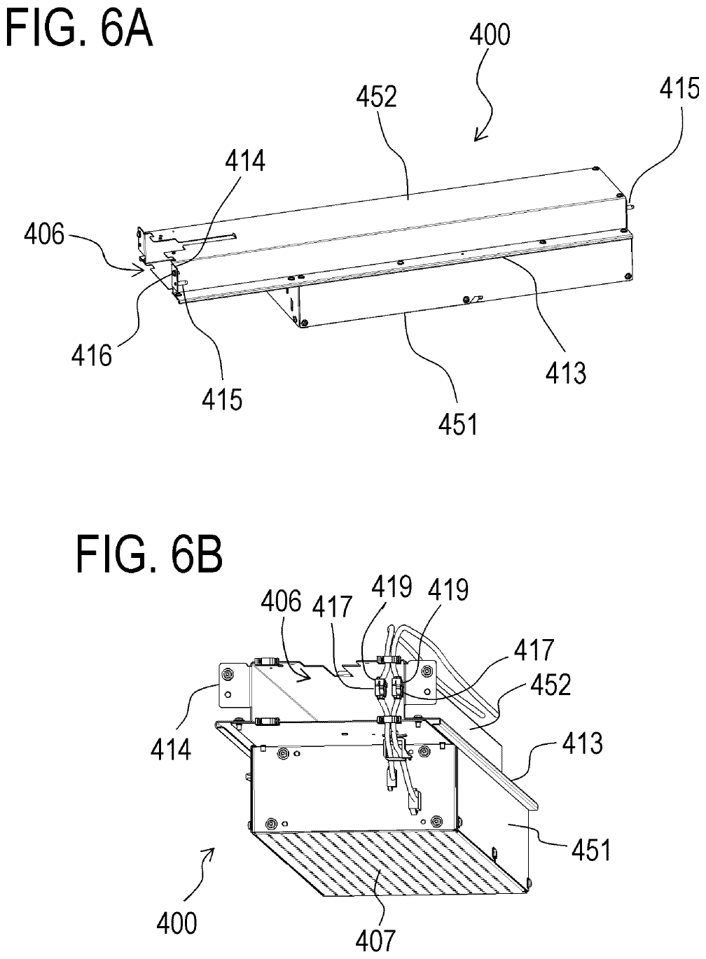

With reference to FIGS. 5A to 6B, an attachment/detachment configuration of the air blowing box 400 with respect to the first housing 401 and the second housing 402 will be described. FIG. 5A is a perspective view illustrating a configuration around an attachment/detachment rail 403 in the first housing 401. FIG. 5B is a perspective view of the air blowing box 400, and illustrates the intake port 406 side. FIG. 5C is a perspective view illustrating a state in which the air blowing box 400 is attached to the first housing 401. FIG. 6A is a perspective view of the air blowing box 400. FIG. 6B is a perspective view illustrating electrical connection between the air blowing box 400 (air blowing fan unit 404) and the main body of the recording apparatus.

Although FIGS. 5A to 6B illustrate the first housing 401, the second housing 402 has a vertically (Z direction) symmetrical configuration with respect to the first housing 401, and illustration of the second housing 402 is omitted.

The air blowing box 400 is attached to and detached from the first housing 401 and the second housing 402 in the width direction (Y direction) of the sheet S. The attachment/detachment rail 403 supports a guided portion 4003 provided in the air blowing box 400, and guides attachment/detachment movement of the air blowing box 400 with respect to the first housing 401 and the second housing 402. A guided portion 413 has a protruding shape protruding outward in the conveyance direction (X direction) of the sheet S from both sides of the air blowing box 400 in a direction orthogonal to the attachment and detachment direction of the air blowing box 400.

The attachment/detachment rail 403 has a groove shape that is recessed in the conveyance direction (X direction) of the sheet S and extends in the width direction (Y direction) of the sheet S.

The guided portion 413 of the air blowing box 400 is inserted into the attachment/detachment rail 403 in the width direction (Y direction) of the sheet S and is fitted in the conveyance direction (X direction) of the sheet S. As a result, the air blowing box 400 is supported by the attachment/detachment rail 403 in the up-down direction (the facing direction of the air blowing box 400 and the sheet S; Z direction) orthogonal to the width direction (X direction) and the conveyance direction (Y direction) of the sheet S. The guided portions 413 are symmetrically disposed on both sides of the air blowing box 400 in the conveyance direction (Y direction) of the sheet S, and are supported by the attachment/detachment rails 403. That is, the air blowing box 400 is sandwiched and supported by the pair of attachment/detachment rails 403 in the conveyance direction (Y direction) of the sheet S, and the movement of the sheet S in the conveyance direction (Y direction) is restricted with respect to the first housing 401 and the second housing 402. The air blowing box 400 is inserted into the first housing 401 and the second housing 402 up to the attachment completion position in the Y direction while the movement thereof in the X direction and the Z direction is restricted by the pair of attachment/detachment rails 403.

The air blowing box 400 includes a contact portion 414 including a surface directed in the insertion direction of the air blowing box 400 with respect to the first housing 401 and the second housing 402, an insertion pin 415 protruding in the insertion direction, and a screw 416 inserted into a screw hole of the contact portion 414. Correspondingly, the first housing 401 and the second housing 402 are provided with a contacted portion 434, a first positioning hole 4351, a second positioning hole 4352, and a screw hole 436. In the present embodiment, in order to absorb an attachment error, a dimensional error, and the like, the first positioning hole 4351 is a round hole, whereas the second positioning hole 4352 is a long round hole.

When the air blowing box 400 is pushed to the attachment completion position, the contact portion 414 comes into contact with the contacted portions 434 of the first housing 401 and the second housing 402, and the insertion pin 415 is inserted into the first positioning hole 4351 and the second positioning hole 4352 of the first housing 401 and the second housing 402. In such a state, the air blowing box 400 is fixed to the first housing 401 and the second housing 402 by tightening the screw 416 to the screw hole 436.

As illustrated in FIG. 6B, in the air blowing box 400, a connector 417 is connected to a connector 419 on the apparatus body side at the attachment completion position, and thus the air blowing fan unit 404 is electrically connected to the control portion 11. When the air blowing box 400 is detached from the first housing 401 and the second housing 402, the connector 417 and the connector 419 are disconnected, and the screw 416 is loosened, so that the air blowing box 400 can be detached from the first housing 401 and the second housing 402.

As described above, the cooling portion 40 according to the present embodiment is configured to detachably hold the plurality of air blowing boxes 400 independently from the first housing 401 and the second housing 402. According to such a configuration, there is an advantage that it is easy to perform apparatus maintenance in a case where some air blowing boxes 400 among the plurality of air blowing boxes 400 fail or in a case where cleaning or the like is performed (see FIG. 3).

### (Configurations of First Housing and Second Housing)

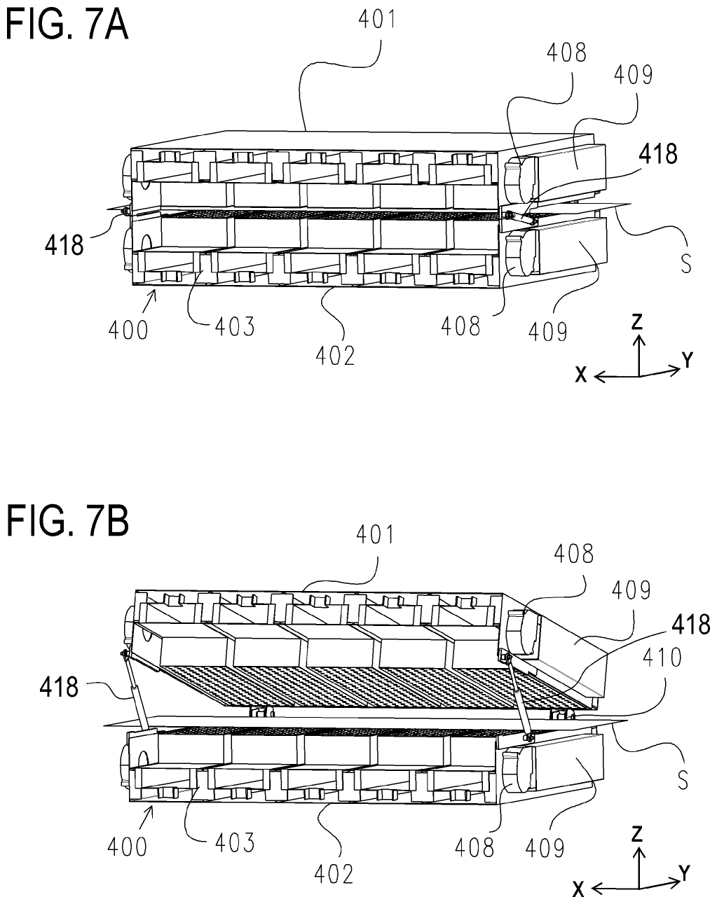

Configurations of the first housing 401 and the second housing 402 will be described with reference to FIGS. 7A and 7B. FIG. 7A is a perspective view of a state in which the first housing 401 and the second housing 402 are close to the sheet S, and FIG. 7B is a perspective view of a state in which the first housing 401 is separated from the sheet S.

As illustrated in FIGS. 7A and 7B, each of the first housing 401 and the second housing 402 includes an exhaust unit 408, an air passage 409, an engagement portion 410, and the like in addition to the attachment/detachment rail 403 described above.

The exhaust unit 408 (air blowing unit) is provided to exhaust a hot air current generated from the sheet S to the outside of the apparatus in conjunction with the air blowing box 400 blowing a cooling air current to the sheet S. In the present example, the exhaust unit 408 is an exhaust fan unit including a fan unit similar to the air blowing fan unit 404. In the present example, the exhaust unit 408 is provided outside each of the first housing 401 and the second housing 402, specifically, outside an inner space for holding the air blowing box 400 in each housing. Air sucked and ejected from the inside of each housing by the exhaust unit 408 is ejected to the outside by exhaust unit (not illustrated) installed in the apparatus body through the air passage 409. The exhaust unit 408 and the air passages 409 are paired on both sides in the conveyance direction (Y direction) of the sheet S in each housing as exhaust portions for discharging the air blown out from the blow-out ports of the air blowing box 400 and applied to the sheet S to the outside.

Note that a disposition configuration of the exhaust unit 408 and the air passage 409 is not limited to the above-described disposition configuration. For example, either one or both of the exhaust unit 408 and the air passage 409 may be provided inside the first housing 401 and the second housing 402.

As illustrated in FIGS. 7A and 7B, the first housing 401 and the second housing 402 are coupled to each other to be relatively rotatable by an engagement portion 410 including a hinge or the like. In the present example, the first housing 401 is configured to be relatively rotatable about the rotation axis in the conveyance direction (Y direction) of the sheet S with respect to the second housing 402.

As described above, the cooling portion 40 of the present example is configured such that the first housing 401 and the second housing 402 can be opened and closed, specifically, the first housing 401 is relatively movable to the air blowing position (first position) and the retraction position (second position) with respect to the second housing 402. During a recording operation of the recording apparatus 1, as illustrated in FIG. 7A, in the cooling portion 40, the first housing 401 is at the air blowing position, and each of the first housing 401 and the second housing 402 is in a closed state of being close to the sheet S (sheet conveyance path). At the time of non-recording operation of the recording apparatus 1 and at the time of sheet passing work of the sheet S or maintenance of the cooling portion 40, the cooling portion 40 can take an open state in which the first housing 401 is moved to the retraction position and the first housing 401 is separated from the sheet S (sheet conveyance path) as illustrated in FIG. 7B.

More specifically, when the air blowing box 400 is moved from the air blowing position to the retraction position, an angle of the blow-out port surface 407 of the air blowing box 400 is changed from the direction facing the sheet S (sheet conveyance path) to the direction facing the side of the sheet S (sheet conveyance path) in the width direction of the sheet S. As a result, the sheet S (sheet conveyance path) is opened to the side, and a space is generated in front of each of the blow-out port surfaces 407 of the upper and lower air blowing boxes 400.

Coupling members 418 including a gas spring or the like are provided between the first housing 401 and the second housing 402 in order to maintain the posture of the first housing 401 having the retraction position. Note that a configuration for maintaining the relative position between the first housing 401 and the second housing 402 may be, for example, a configuration in which a locking portion for locking and holding the first housing 401 at the retraction position is provided in the frame body 412 of the cooling portion 40, and is not limited to a specific configuration.

In addition, in the present example, a configuration in which the second housing 402 is fixed to the frame body 412 of the cooling portion 40 and the first housing 401 can be opened and closed has been described, but an opening/closing configuration is not limited thereto. The first housing 401 may be fixed, and the second housing 402 may be configured to be openable and closable, or both the first housing 401 and the second housing 402 may be configured to be openable and closable.

As a result, by moving the first housing 401 or the second housing 402 to the center of the rotation axis of the engagement portion 410, the plurality of held air blowing boxes 400 can be retracted from the sheet S all at once, and a work time of the sheet passing and the sheet jam processing can be shortened.

Note that the rotation axis of the engagement portion 410 is not limited to being parallel to the sheet conveyance direction, and may be in a direction perpendicular to the sheet conveyance direction as long as the conveyance of the sheet S is not hindered. That is, an aspect in which the sheet conveyance path or the blow-out port surface 407 of the air blowing box 400 is opened to facilitate access from the outside is not limited to the opening/closing configuration as in the present example. For example, the sheet conveyance path or the blow-out port surface 407 of the air blowing box 400 may be opened by separating the first housing 401 and the second housing 402 to widen mutual facing intervals while maintaining the respective horizontal postures.

### (Intake/Exhaust Circulation of Cooling Portion)

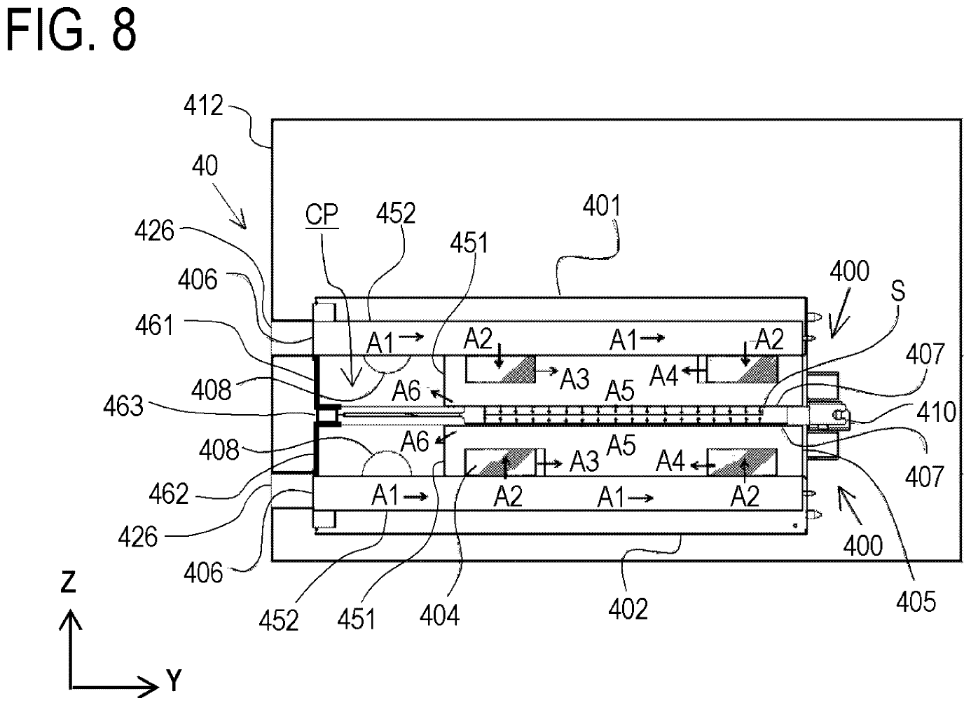

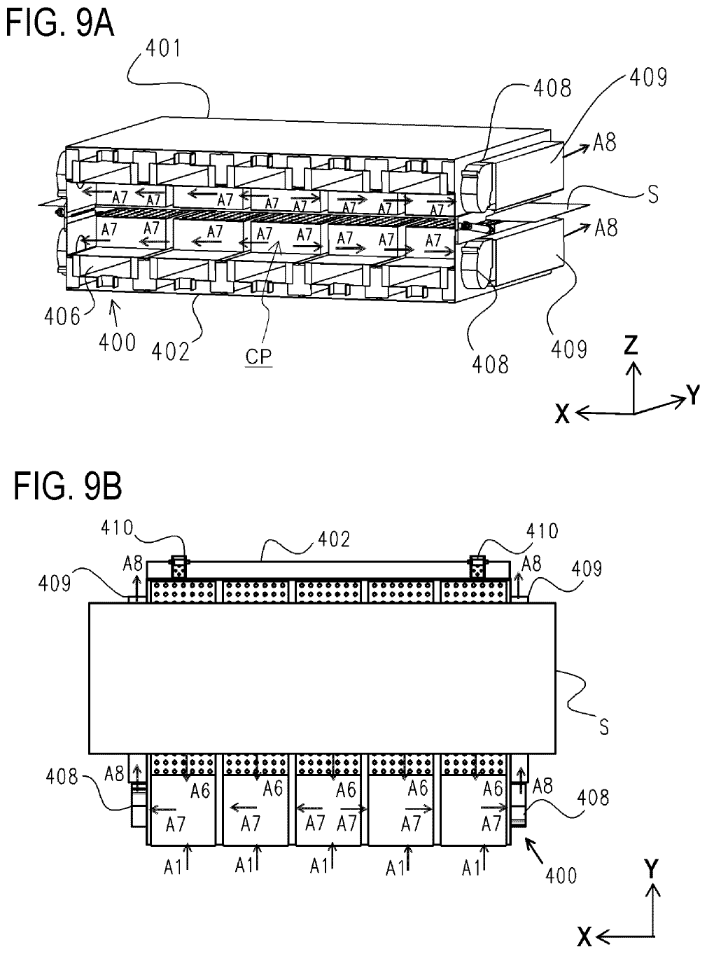

The overall intake/exhaust circulation of the cooling portion 40 will be described with reference to FIGS. 8 to 9B. FIG. 8 is a schematic cross section of the cooling portion 40 as viewed from the sheet conveyance direction (perpendicular to the sheet conveyance direction), and directions of an air flow formed in the cooling portion 40 are indicated by arrows A1 to A6. FIG. 9A is a schematic perspective view of the cooling portion 40 as viewed from the front side, and directions of an air flow formed in the cooling portion 40 are indicated by arrows A7 and A8. Note that, in FIG. 9A, a partition wall 461 of the first housing 401, a partition wall 462 of the second housing 402, and a sealing member 463 (see FIG. 7) are not illustrated, and the flow of the air flow is easily viewed. FIG. 9B is a schematic plan view of the second housing 402 of the cooling portion 40 as viewed from the top surface side, and directions of the air flow are indicated by arrows A1 and A5 to A8.

First, the circulation of the air flow inside the air blowing box 400, the first housing 401, and the second housing 402 will be described with reference to FIG. 8.

The intake port 406 of the air blowing box 400 is open to the outside of the cooling portion 40 through an opening portion 426 that is open to the side surface of the frame body 412 of the cooling portion 40 on one side in the width direction of the sheet S. Air is taken in from the outside through the intake port 406 by the air flow in the directions of the arrows A1 and A2, which is formed inside the second box portion 452 of the box housing 405 due to an air blowing operation of the air blowing fan unit 404. The air blowing fan unit 404 ejects the air taken into the second box portion 452 of the box housing 405 into the first box portion 451 of the box housing 405 in the directions of the arrows A3 and A4, and circulates the air in the first box portion 451. The air sequentially ejected from the air blowing fan unit 404 into the first box portion 451 of the substantially sealed box housing 405 increases the internal pressure of the first box portion 451 and forms an air flow blown out in the direction of the arrow A5 from the blow-out ports of the blow-out port surface 407 toward the sheet S.

The sheet S passes through the drying portion 20 and the fixing portion 30, and then enters the cooling portion 40 with heat (see FIG. 1). After an air current is blown from the blow-out ports of the air blowing box 400 to the sheet S that has entered the cooling portion 40, the air warmed by the heat of the sheet S is reflected in the direction of the arrow A6.

In the cooling portion 40 of the present example, a space that is an escape space for the air (arrow A6) is formed on one side in the width direction (Y direction) of the sheet S with respect to the conveyance space of the sheet S (a facing space of the blow-out port surfaces 407 directed in the up-down direction (Z direction)). This space is a space surrounded by both side walls of the first box portion 451, the second box portion 452, a first partition wall 461, a second partition wall 462, the sealing member 463, the first housing 401, and the second housing 402 in the conveyance direction (X direction) of the sheet S. In this space, the suction ports of the exhaust unit 408 provided on the both side walls of the first housing 401 and the second housing 402 are open. That is, this space extends from one end to the other end of the first housing 401 and the second housing 402 in a direction (the conveyance direction of the sheet S) in which a plurality of pairs of the vertically facing air blowing boxes 400 are arranged, and serves as a common exhaust passage CP in the plurality of air blowing boxes 400. At both ends of the common exhaust passage CP in the conveyance direction of the sheet S, the suction ports of the exhaust unit 408 are open vertically. The air leaking from the facing space of the pairs of vertically facing air blowing boxes 400 is collected in the common exhaust passage CP and collectively discharged by the plurality of pieces of exhaust unit 408.

Here, the first partition wall 461 is fixed to the first housing 401, the second partition wall 462 is fixed to the second housing 402, and the sealing member 463 is provided to seal between the first partition wall 461 and the second partition wall 462. The sealing member 463 is fixed to the second partition wall 462, and the first partition wall 461 is configured to take a sealed state of being in close contact with the sealing member 463 and a separated state of being separated from the sealing member 463 in accordance with the opening and closing operations of the first housing 401. Note that the sealing member 463 may be configured to be fixed to the first partition wall 461, or a configuration may be adopted in which a sealing member is provided on each of the first partition wall 461 and the second partition wall 462 and the sealing members are sealed and joined to each other.

When the air blowing box 400 is attached to and detached from the first housing 401, the first partition wall 461 is detached from the first housing 401. Similarly, when the air blowing box 400 is attached to and detached from the second housing 402, the second partition wall 462 is detached from the second housing 402.

The first partition wall 461, the second partition wall 462, and the sealing member 463 are illustrated only in FIG. 8, and are not illustrated in FIG. 9A in order to easily view the flow of the air flow in the common exhaust passage described above.

Next, circulation of an air flow outside the air blowing box 400, the first housing 401, and the second housing 402 will be described with reference to FIGS. 9A and 9B.

The air warmed by the heat of the sheet S is reflected in the direction of the arrow A6 toward the common exhaust passage CP, and flows in the direction of the arrow A7 due to the exhaust unit 408 taking in air. Thereafter, the air is discharged in the A8 direction from the ejection port of the exhaust unit 408. The air passage 409 is connected to the ejection port of the exhaust unit 408. The air passage 409 is integrally provided in each of the first housing 401 and the second housing 402. The air ejected from the ejection port of the exhaust unit 408 is sent to exhaust unit (not illustrated) installed in the apparatus body via the air passage 409, and is discharged to the outside of the cooling portion 40 via the exhaust unit.

Here, in PTL 1 (Japanese Patent Application Publication No. 2014-172226), air taken in from the intake port is discharged from the blow-out port and blown to a recording medium. In this case, warm air bouncing off the recording medium is naturally exhausted from the space between the air blowing box and the side plate. Therefore, the exhausted air may stay around the cooling mechanism.

According to the cooling portion 40 of the present example, by the exhausted air flow formed by the exhaust portion including the exhaust unit 408, the air passage 409, and the like, the air taken in from the outside and blown and reflected on the sheet S can be efficiently discharged to the outside without staying in the cooling portion.

In the present example, the sirocco fan is used as the air blowing fan unit 404 (air blowing unit) and the exhaust unit 408, but the present disclosure is not limited thereto. A fan of a different type, an external air blower, or the like may be substituted.

### <Flow Velocity Control of Cooling Portion 40>

### (Flow Velocity Control Based on Rotation Speed of Air Blowing Fan)

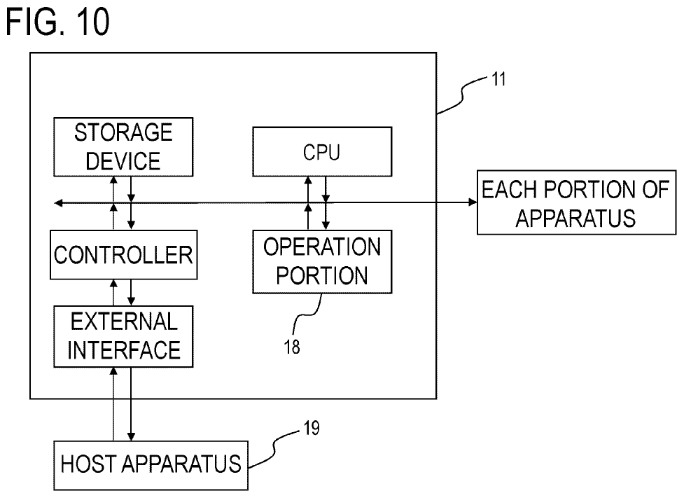

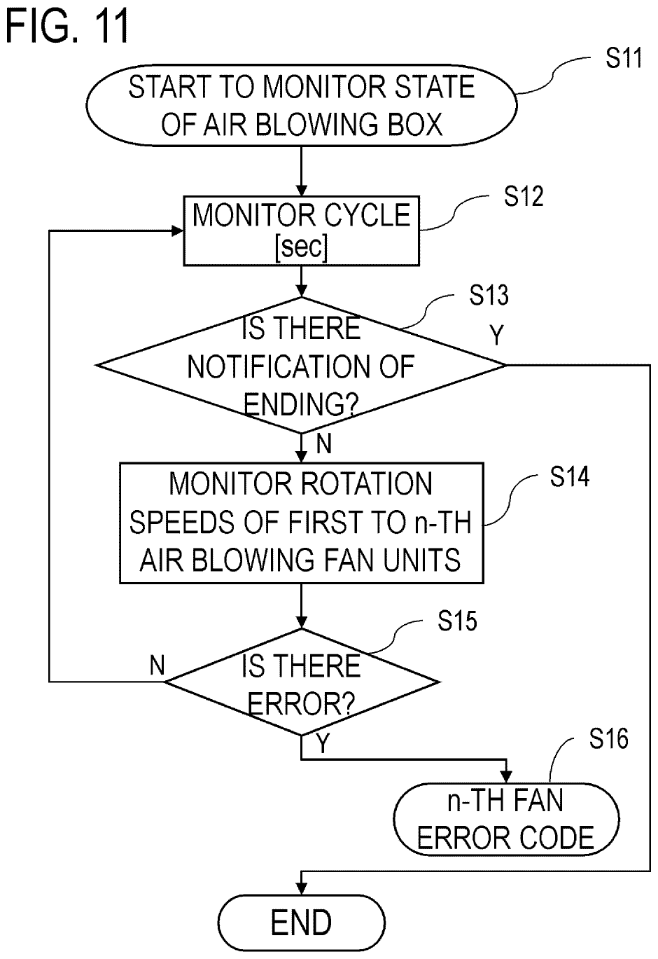

With reference to FIGS. 10 and 11, flow velocity control of the cooling portion 40 of Example 1 will be described. FIG. 10 is a control block diagram of the recording apparatus according to the present embodiment. FIG. 11 is a flowchart illustrating flow velocity control based on a rotation speed of the air blowing fan unit.

A control procedure of the cooling portion 40 performed by the control portion 11 will be described. When recording data is transmitted from a host apparatus 19 to the control portion 11, a recording preparation operation is started in the apparatus (S11). The control portion 11 determines a driving table value for the cooling portion 40 on the basis of recording conditions. Conditions for a driving table are determined on the basis of the type of a recording medium, a recording density, and a value designated by a user. Driving DUTY of an air blowing source (the motor of the air blowing fan unit 404) is designated according to the conditions (S12). DUTY indicates a driving pulse duty cycle of the air blowing source and provides a driving signal between 0% stop and 100% full speed rotation.

In the present embodiment, an air volume of each air blowing box 400 is adjusted by the driving DUTY of the air blowing source, but the present disclosure is not limited to this means. For example, pressure detection means (not illustrated) may be provided in each air blowing box 400, a pressure value in the air blowing box may be set as a target value, and the air blowing source may be feedback-controlled on the basis of a detected pressure value.

In the process of blowing an air current onto the sheet S, the rotation speed of the air blowing fan unit 404 is monitored via, for example, an encoder (not illustrated) (S14). The internal pressure can be indirectly monitored by correlating the rotation speed of the air blowing fan unit 404 and the internal pressure in the air blowing box 400 in advance. As a result, it is possible to predict a flow velocity of an air current flowing out from the blow-out ports of the blow-out port surface 407 and to detect a failure of the air blowing fan unit 404. Unless a failure is detected (S15, S16) in any of the plurality of air blowing fan units 404, the monitoring in the encoder is continued until the recording operation (cooling operation) ends (S13).

In addition, by associating the rotation speed of the air blowing fan unit 404 with a value of the encoder that reads the rotation speed of the air blowing fan unit 404, the rotation speed of the air blowing fan unit 404 can be controlled according to an instruction from the control portion 11 while monitoring an encoder value. As a result, it is possible to control the flow velocity of the air current flowing out from the plurality of blow-out ports of the blow-out port surface 407.

The above control is individually performed on the plurality of air blowing boxes 400 held by the first housing 401 and the second housing 402. As a result, for example, it is possible to perform control such that the flow velocity of the air blowing box 400 on the upstream side in the conveyance direction (X direction) of the sheet S is higher than the flow velocity of the air blowing box 400 on the downstream side, or vice versa.

In the configuration in which the plurality of air blowing fan units 404 are provided in one air blowing box 400 as in the present example, the plurality of air blowing fan units 404 may be separately controlled. With such a configuration, it is possible to change a flow velocity of an air current which flows out from the blow-out ports of the blow-out port surface 407 in the width direction (Y direction) of the sheet S.

According to the above control configuration, it is possible to individually and independently control the flow velocity of the air current flowing out from the blow-out ports of each of the plurality of blow-out port surfaces 407 arranged in the conveyance direction of the sheet S. For example, it is possible to perform control such that the flow velocity of the air current flowing out from the blow-out ports of the air blowing box 400 increases as the air blowing box is disposed toward the downstream side in the conveyance direction among the plurality of air blowing boxes 400 arranged in the conveyance direction of the sheet S. Therefore, for example, in a case where a material of the sheet S is a film material such as PET, in order to avoid thermal contraction due to a rapid temperature change, it is possible to perform control such as gradually increasing the flow velocity of the air current flowing out from the blow-out ports of the blow-out port surface 407 from the upstream side toward the downstream side in the conveyance direction of the sheet S.

In addition, for example, the flow velocity of the air current from the first air blowing fan unit 404 and the flow velocity of the air current from the second air blowing fan unit 404 may be controlled to be different from each other according to the content of recording data transmitted from the host apparatus 19 to the control portion 11. For example, in the width direction of the sheet S, when an image in which ink is concentrated is formed on the front side as a pattern formed on the sheet S, it is possible to perform control such as increasing the flow velocity of the air current flowing out from the plurality of blow-out ports of the blow-out port surface 407 on the front side with respect to the back side. This leads to improvement in appearance of the image.

### Cooling Portion 40 of Example 2

### (Flow Velocity Control Using Pressure Sensor)

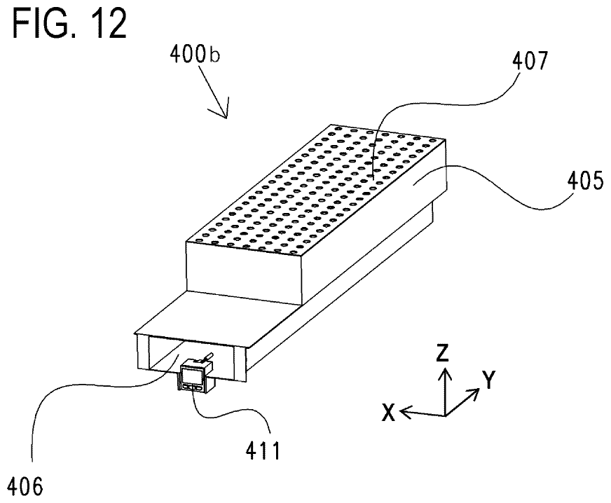

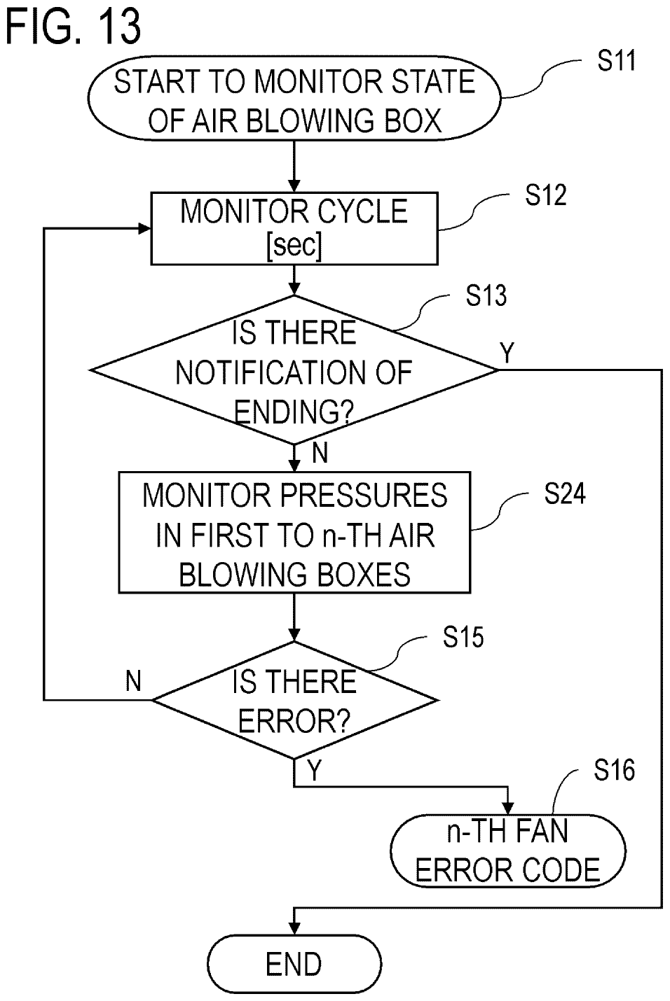

An embodiment of another configuration of applying an air current of the cooling portion 40 to cool the ink applied surface will be described with reference to FIGS. 12 and 13. FIG. 12 is a perspective view of an air blowing box 400b in Example 2. FIG. 13 is a flowchart illustrating flow velocity control using a pressure sensor. Here, among the configurations of the air blowing box 400b of Example 2, the same configurations as those of the air blowing box 400 of Example 1 are denoted by the same reference numerals, and the description thereof will be omitted.

As illustrated in FIG. 12, the air blowing box 400b includes an air blowing fan unit 404 (not illustrated), a box housing 405, an intake port 406, a blow-out port surface 407, and a pressure sensor 411. The pressure sensor 411 is provided to measure the internal pressure of the air circulating in the box housing 405.

A control procedure of the cooling portion in Example 2 illustrated in FIG. 13 is obtained by replacing S14 in the control procedure of Example 1 illustrated in FIG. 11 with S24. That is, in the present example, in the process of blowing an air current to the sheet S, the internal pressure of the air passage of the box housing 405 of each air blowing box 400b is monitored by using the pressure sensor 411 (S24). Other steps in the control procedure of Example 2 are the same as those of Example 1, and the description thereof will be omitted.

As the pressure sensor 411, for example, a sensor having a configuration in which a diaphragm is provided in a pressure receiving portion and a strain gauge is formed on a surface of the diaphragm may be used. When the diaphragm is deformed by receiving the pressure, a resistance change occurs in the strain gauge, and the resistance change is converted into an electrical signal, whereby the pressure is detected and measured. By monitoring the internal pressure of the air passage of the box housing 405, it is possible to predict the flow velocity of the air current flowing out from the plurality of blow-out ports of the blow-out port surface 407 and to detect a failure of the air blowing fan unit 404.

In addition, by associating the rotation speed of the air blowing fan unit 404 with the value of the pressure sensor 411 described above, the rotation speed of the air blowing fan unit 404 can be controlled according to an instruction from the control portion 11 while monitoring a sensor value. As a result, it is possible to control the flow velocity of the air current flowing out from the plurality of blow-out ports of the blow-out port surface 407.

The above control is individually performed on the plurality of air blowing boxes 400b held by the first housing 401 and the second housing 402. As a result, for example, it is possible to perform control such that the flow velocity of the air blowing box 400b on the upstream side in the conveyance direction (X direction) of the sheet S is higher than the flow velocity of the air blowing box 400b on the downstream side, or vice versa.

In the configuration in which the plurality of air blowing fan units 404 are provided in one air blowing box 400b as in the present example, the plurality of air blowing fan units 404 may be separately controlled. With such a configuration, it is possible to change a flow velocity of the air current which flows out from the blow-out ports of the blow-out port surface 407 in the width direction (Y direction) of the sheet S. According to the above control configuration, it is possible to individually and independently control the flow velocity of the air current flowing out from the blow-out ports of each of the plurality of blow-out port surfaces 407 arranged in the conveyance direction of the sheet S. Therefore, for example, in a case where a material of the sheet S is a film material such as PET, in order to avoid thermal contraction due to a rapid temperature change, it is possible to perform control such as gradually increasing the flow velocity of the air current flowing out from the blow-out ports of the blow-out port surface 407 from the upstream side toward the downstream side in the conveyance direction of the sheet S.

In addition, for example, the flow velocity of the air current from the first air blowing fan unit 404 and the flow velocity of the air current from the second air blowing fan unit 404 may be controlled to be different from each other according to the content of recording data transmitted from the host apparatus 19 to the control portion 11. For example, in the width direction of the sheet S, when an image in which ink is concentrated is formed on the front side as a pattern formed on the sheet S, it is possible to perform control such as increasing the flow velocity of the air current flowing out from the plurality of blow-out ports of the blow-out port surface 407 on the front side with respect to the back side. This leads to improvement in appearance of the image. By adopting the configuration described above and retracting the plurality of air blowing boxes detachably held by the first housing or the second housing from the sheet all at once, it is possible to shorten the work time of the sheet passing and the sheet jam processing. In addition, apparatus maintainability can be improved. Further, by integrally providing the exhaust unit and the air passage in the first housing or the second housing, intake and exhaust circulation can be made efficient.

### OTHER EMBODIMENTS

In the present embodiment, a plurality of air blowing boxes independently detachably held by the first housing or the second housing have been described as an example, but the present disclosure is not limited thereto. For example, even in a form in which the first housing or the second housing holding the plurality of air blowing boxes can be pulled out as a unit, the same effects as those of the present embodiment can be expected.

As means for flow velocity control, instead of measuring a rotation speed and a pressure of the fan, a flow velocity of an air current flowing out of the blow-out ports may be directly measured by an anemometer or the like and used for control, or a flow rate of air in the box housing may be directly measured by a flow rate sensor and used for control.

In the above embodiment, the case where the air blowing mechanism (air blowing portion) of the present disclosure is applied to the cooling portion of the recording apparatus has been described, but an application scope of the present disclosure is not limited thereto. For example, the present disclosure may also be applied to, for example, an air blowing mechanism (drying unit or fixing unit) that applies a hot air current to ink to dry the ink or controls a melted state of the ink to promote fixing to a recording material.

In each of the above-described embodiments, respective configurations can be combined with each other as much as possible.

The present disclosure is not limited to the above embodiments, and various changes and modifications can be made without departing from the spirit and scope of the present disclosure. Accordingly, the following claims are appended to make the scope of the present disclosure public.

According to the present disclosure, maintainability of the recording apparatus can be improved.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A recording apparatus comprising:
a conveyance portion that conveys a sheet; and
an air blowing portion that applies an air current to the sheet conveyed by the conveyance portion, wherein
the air blowing portion includes
an air blowing box that has a blow-out port through which the air current to be applied to the sheet is blown, and
a holding portion that holds the air blowing box, and is configured to be movable such that the air blowing box takes a first position where a blow-out port surface provided with the blow-out port faces a conveyance path of the sheet, and a second position where the blow-out port surface is further away from the conveyance path than in a case where the first position is taken, and wherein
the air blowing box is configured to be attachable to and detachable from the holding portion.

2. The recording apparatus according to claim 1, wherein in a case where the air blowing box is moved from the first position to the second position, an angle of the blow-out port surface is changed from an orientation facing the conveyance path to an orientation facing a side of the conveyance path.

3. The recording apparatus according to claim 1, wherein the holding portion holds a plurality of the air blowing boxes.

4. The recording apparatus according to claim 3, wherein the plurality of air blowing boxes is disposed to be arranged in a conveyance direction of the sheet.

5. The recording apparatus according to claim 4, further comprising a control portion, wherein
the air blowing box includes a motor, the rotation speed of which is controlled by the control portion, and includes an air blowing fan unit that forms an air flow in which air is introduced from outside of the air blowing box and blown out from the blow-out port, and
the control portion individually controls a rotation speed of each of a plurality of the motors to individually control a flow velocity of an air current flowing out from the blow-out port of each of the plurality of air blowing boxes.

6. The recording apparatus according to claim 5, further comprising a pressure sensor that detects an internal pressure of an air passage of the air blowing box, wherein the control portion controls the rotation speed of the motor on the basis of the internal pressure detected by the pressure sensor.

7. The recording apparatus according to claim 5, wherein, from among the plurality of air blowing boxes, as the air blowing box is disposed toward a downstream side in the conveyance direction, the flow velocity of the air current flowing out from the blow-out port increases.

8. The recording apparatus according to claim 5, wherein
the air blowing box includes a first air blowing fan unit and a second air blowing fan unit as the air blowing fan unit,
the first air blowing fan unit ejects air introduced from the outside of the air blowing box toward a side where the second air blowing fan unit is disposed in the air blowing box, and
the second air blowing fan unit blows out air introduced from the outside of the air blowing box toward a side where the first air blowing fan unit is disposed in the air blowing box.

9. The recording apparatus according to claim 8, wherein the control portion individually controls a rotation speed of a motor of the first air blowing fan unit and a rotation speed of a motor of the second air blowing fan unit.

10. The recording apparatus according to claim 9, wherein the rotation speed of the motor of the first air blowing fan unit and the rotation speed of the motor of the second air blowing fan unit are different from each other.

11. The recording apparatus according to claim 8, wherein the first air blowing fan unit is disposed on one side in a width direction of the sheet orthogonal to the conveyance direction, and the second air blowing fan unit is disposed on the other side in the width direction.

12. The recording apparatus according to claim 1, further comprising an exhaust portion that discharges, to outside, air blown out from the blow-out port and applied to the sheet.

13. The recording apparatus according to claim 1, wherein the air current applied to the sheet by the air blowing portion is a cooling air current.

14. The recording apparatus according to claim 1, further comprising: with the air blowing box being a first air blowing box, and the holding portion being a first holding portion,
a second air blowing box that has a blow-out port that blows out an air current to be applied to a second surface of the sheet opposite to a first surface to which the first air blowing box applies the air current; and
a second holding portion that holds the second air blowing box.

15. The recording apparatus according to claim 14, wherein
the first air blowing box is configured to be attachable to and detachable from the first holding portion, and
the second air blowing box is configured to be attachable to and detachable from the second holding portion.

16. The recording apparatus according to claim 1, wherein
the conveyance portion includes
a supply portion that supplies the sheet to the conveyance path, and
a collection portion that collects the sheet from the conveyance path. and wherein
the sheet is a continuous sheet from the supply portion to the collection portion.
